(19) United States
(12) Patent Application Publication
(10) Pub. No.: US 2003/0182447 A1
(43) Pub. Date: Sep. 25, 2003

(54) Generic top-level domain re-routing system

(76) Inventor: Frank T. Schilling, British Columbia (CA)

Correspondence Address: DANN, DORFMAN, HERRELL & SKILLMAN, 1601 MARKET STREET, SUITE 2400, PHILADELPHIA, PA, 19103-2307, US

(21) Appl. No.: 09/949,565

(22) Filed: Sep. 10, 2001

Related U.S. Application Data
(60) Provisional application No. 60/294,727, filed on May 31, 2001.

(51) Int. Cl. G06F 15/16

(52) U.S. Cl. 709/245

(57) ABSTRACT

A domain name server is provided with a set of pseudo domains corresponding to typographical variation of registered domains. The domain name server is configured to provide an error-correction response to a query corresponding to a pseudo domain. The domain name server may be implemented as a TLD server, a root server, or as an adjuct to a network DNS cache, among other embodiments.

### CROSS REFERENCE TO RELATED APPLICATIONS

Priority is claimed herein to U.S. Provisional Application No. 60/294,727, filed May 31, 2001.

### FIELD OF THE INVENTION

The present invention relates to an improvement of the Internet domain name system (DNS). In particular, the invention relates to a method of providing name resolution for domain names having mis-typed or mis-spelled top-level domains (TLDs) in order to reduce mis-directed web traffic and e-mail messages.

### INTRODUCTION

One of the fundamental features which has contributed to the explosive growth and utility of the Internet is the domain name system (DNS). At a basic technical level, resources on the Internet are accessed according to Internet Protocol addresses (IP addresses). Each IP address is a quartet of two-byte values of the form NNN.NNN.NNN.NNN. As the quantity of resources connected to the Internet began to grow from its inception, it was soon realized that a host naming system would allow users to more easily locate resources. Initially, a host naming system employing a single ASCII file, HOSTS.TXT, which associated host names and IP addresses, was centrally maintained and periodically distributed to permit name-based addressing. However, as the number of hosts connected to the Internet continued to grow, the Internet domain name system (DNS) was developed.

The DNS is a distributed hierarchical address system in which Internet domain names are specified by alphanumeric strings, called domains, separated by dots into successive “levels” of domains. At the bottom of the hierarchy is a file called the “root zone”. The root zone identifies a set of “top-level domains” (TLDs), and the Internet protocol addresses at which further information can be obtained for second-level domains in each of the top-level domains. The root zone is stored on a computer known as a root server. In the root server system operated under the authority of the U.S. Department of Commerce, the root zone is copied to each of a system of thirteen root servers distributed around the world, of which one, the “A root server” contains the authoritative root zone file. The authoritative root zone file contains the familiar generic top-level domains (gTLDs) of .com, .net and org, specialized TLDs such as mil, .edu, .gov, and .int, as well as over 250 country-code TLDs (ccTLDs) based on the ISO-3166 two-letter country-code designations. The Department of Commerce has delegated policy authority over the root zone to the Internet Corporation for Assigned Names and Numbers (ICANN), which has approved the addition of several more TLDs to the root zone, .biz, .info, .name, .museum, .aero, .pro, and .coop.

In parallel with the Department of Commerce root server system, several private root server systems, such as the Open Root Server Confederation (ORSC), have launched a large variety of TLDs to supplement those contained in the Department of Commerce root server system. Often inaccurately called “alternative roots”, such private root systems provide an enhanced, or inclusive, name space, which mirrors data in the Department of Commerce root while providing additional zone data for TLDs which are not in the Department of Commerce root, rather than to provide an “alternative” to the widely-used TLDs in that root server system. Inclusive root systems offer Internet users a choice in name resolution service, and rely on cooperation among root server operators to avoid duplication of TLDs.

When an Internet user specifies an address, such as by typing a domain name into a browser, the user's computer launches an iterative address resolution process, referred to herein as a resolver. A resolver program may be embodied as a common resource of the user's computer, such as in the network settings therein, or may be built into various applications, such as browsers, email programs, file transfer programs, messaging programs, and another other application which utilizes Internet resources. The resolver includes, as one of its settings, the address of a name server, from which DNS information may be retrieved. In general, DNS name service is provided by the user's Internet service provider, although DNS name service may be provided by other servers specified by the user, or by the user's local host. Wherever performed, the processor shall herein be referred as the “resolver”.

A typical address requested by a web browser may be of the form http://www.example.com. The first step in the process is for the resolver to instruct the name server to query the root zone in order to find where to locate the zone file for “.com”. Hence, the user's name server obtains, from the root server, the IP address of the .com zone name server. Then, the user's name server queries the .com zone server to provide the address of the name server for “example” in the .com zone. After obtaining the IP address of the example.com name server, the user's name server further queries the example.com name server to find the IP address of the “www” zone. At this point, the address is fully resolved, and the name server for www.example.com provides the ultimate IP address for “http” (hypertext transfer protocol) queries directed to www.example.com. When this address is obtained, the server which hosts the ultimate IP address is known, and the browser may send an http service request to port 80 (the default port for http queries) of the server. The zone file for “example.com” may provide IP addresses for other sorts of queries, such as mail routing, file transfer protocol, etc. By distributing Internet address information in this manner, the task of locating Internet resources is distributed among the name servers for successive levels of the domain name system, which also allows resources designated under each domain name to be flexibly allocated without requiring central administration of each zone, other than the root zone.

When one considers the address resolution process, it becomes apparent that each resolution query begins by interrogating the root zone for the location of the TLD server for the specified TLD. As described thus far, it should be apparent that an enormous amount of address resolution traffic on the Internet is directed to the root server system as the first step of address resolution. In order to alleviate the load on the actual root servers, DNS servers are commonly configured to temporarily store, or cache, the results of recent queries. Hence, each entry in a zone file includes a time-to-live (TTL) value which specifies a period of time for which a DNS server should consider a particular address to validly correspond to a domain. Caching considerably reduces the load on the root servers, which would otherwise receive and respond to a query every time any user on the Internet required address resolution. With caching, DNS servers query the root server for a particular TLD only as often as the TTL specified in the root zone for each TLD record.

Even with caching of DNS records, the root servers must handle a large volume of queries. These queries originate from DNS servers from which data has exceeded its TTL, and from queries which have been specified to obtain only an authoritative answer. However, a much larger amount of root server queries, and possibly the single largest source of root server queries, are made as a result of mis-typed or mis-spelled TLDs. While any name server in the chain of events for resolving “www.example.com” may have cached the location of the “.com” zone file, no DNS server will have address information for the mistyped address “www.example.cpm”. Because the letter “p” is located adjacent to the letter “o” on a standard “QWERTY” keyboard, “.cpm” is a common misspelling of “.com”. The absence of zone data for “.cpm” in any DNS cache will cause the resolver query for “.cpm” to be passed to the authoritative root server, and for the authoritative root server to provide a “not found” response. Consequently, no zone data will be cached in the upstream DNS servers, and the root server will necessarily receive every subsequent query for “.cpm”. Additionally, because the query for “.cpm” must be passed to the authoritative root, address resolution for mis-typed domains actually takes longer than for correctly typed domains, as the resolver must wait for until it receives the “not found” response from the possibly distant root server, or at least until the resolver reaches its specified time-out interval. This time delay is an inconvenience for the user, who may not have noticed the mis-typed TLD. The user might also conclude that the intended address does not exist, resulting in a loss of traffic for the intended destination.

### SUMMARY OF THE INVENTION

In accordance with the present invention, it has been observed existing TLDs are each prone to frequent and relatively consistent mis-typed variations. Because mis-typed TLDs in Internet domain names will not resolve to a valid address, valuable web site visitors and e-mail messages are lost. Additionally, mis-typed TLDs are not present in network root services to respond to queries for non-existent TLD's. Hence, it is desirable to provide an address resolution mechanism to reduce root server address resolution traffic and to provide increased user convenience. According to one embodiment of the invention, the root zone file is augmented to include DNS records corresponding to common mis-typed versions of the correctly-typed TLDs contained in the root zone. The DNS data for each mis-typed TLD is configured to be identical with the DNS data for the corresponding correctly-typed TLD. When a query is received for an mistyped TLD, the root server will respond by providing the IP address for the intended correctly typed TLD. As a result, the resolution process will then be referred to the intended name server for the intended TLD, and subsequent queries to the root server will be reduced as a consequence of caching the authoritative response for the mis-typed TLD. In alternative embodiments, supplemental DNS data for mis-typed domains may be provided upstream from the root server, in the form of an augmented cache at an intermediate DNS server, or on the user's computer.

In further alternative embodiments, the supplemental DNS data for mistyped domains may respond to mis-typed TLD queries by providing an “address correction” response, in order to prompt the user that a TLD has been mis-typed, offer an alternative, and/or notify the user of a mis-typed TLD. It will be appreciated that the present invention is operative to correctly route address queries resulting from user mis-typings of TLDs, and to correctly route malformed address queries resulting from typographical errors on web pages or embedded within executable code for various Internet applications. Further features and advantages of the present invention will be made apparent in the Detailed Description below.

### DESCRIPTION OF THE FIGURES

The foregoing summary, as well as the following Detailed Description, will be best understood in connection of the attached figures in which:

FIG. 1 is a block functional diagram of an address resolution system in accordance the invention, including features utilized in connection with an alternative embodiment of the invention shown in dashed lines; and

FIG. 2 is a diagram of data contained within a root zone file and within supplemental DNS entries utilized in the invention described below in connection with FIG. 1.

### DETAILED DESCRIPTION

Detailed embodiments of the invention and alternatives shall be described below in connection with address resolution for access to web pages. It will be understood that the method of the present invention is applicable to other processes utilizing Internet addresses, such as for connection of e-mail addresses.

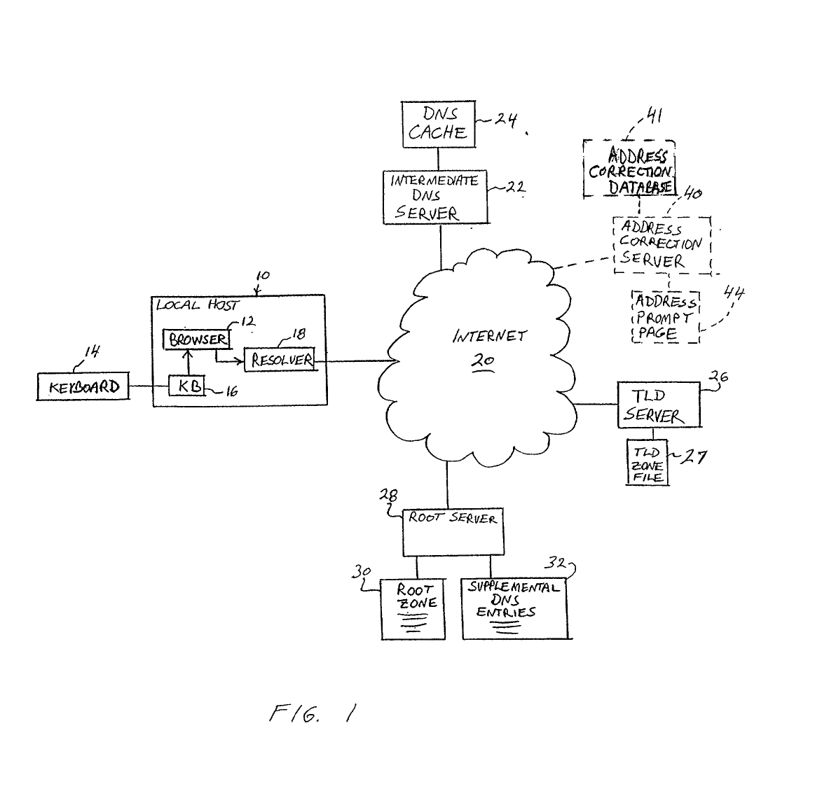

Referring now to FIG. 1, there is shown a local host 10, such as a personal computer, which is connected to the Internet 20. The local host 10 is configured to execute an Internet application, such as web browser process 12. The local host 10 is connected with a keyboard 14 by which a user may enter a Uniform Resource Locator (URL) into the web browser via a keyboard interface 16 in order to obtain a desired web page. The URL includes a domain name consisting of an intended TLD, above which is a second-level domain (SLD) and, optionally, additional higher level domains. The local host 10 includes a resolver process 18 which is accessed by the web browser 12 in order to obtain the IP address of the host server for the desired domain name.

The resolver 18 is configured to refer address queries to an intermediate name server 22, preferably a DNS server operated by an Internet service provider. The first step in the address resolution process is to obtain the location of the TLD server for the intended TLD, for example the “.com” zone server 26. The TLD server maintains a filed which provides the addresses of authoritative name servers for each name registered in the TLD, such as in the .com zone file 27. The intermediate name server 22 may be provided with a DNS cache 24 which stores DNS data retrieved in recent previous address resolution queries. If DNS data for the specified TLD is not stored in the cache 24, then the intermediate name server queries a root server 28 to obtain the IP address of the desired TLD server.

Upon receiving a query to obtain a TLD server address, the root server consults a root zone file 30. The root zone 30 file contains IP addresses of TLD servers for all TLDs serviced by the root server 28. Traditionally, if the requested TLD is not entered in the root zone file 30, then a root server would respond with a “not found” response. However, the root server 28 is provided with a set of supplemental DNS entries 32 for a set of pseudo TLDs. The supplemental DNS entries may be contained in a secondary root zone file 32, which is queried of the requested TLD is not found in the root zone file 30. Alternatively, the supplemental DNS entries may be provided within the root zone file 30 itself. Each of the DNS entries in the root zone file and among the supplemental DNS entries includes a respective TLD or pseudo TLD, and an IP address corresponding to a TLD server.

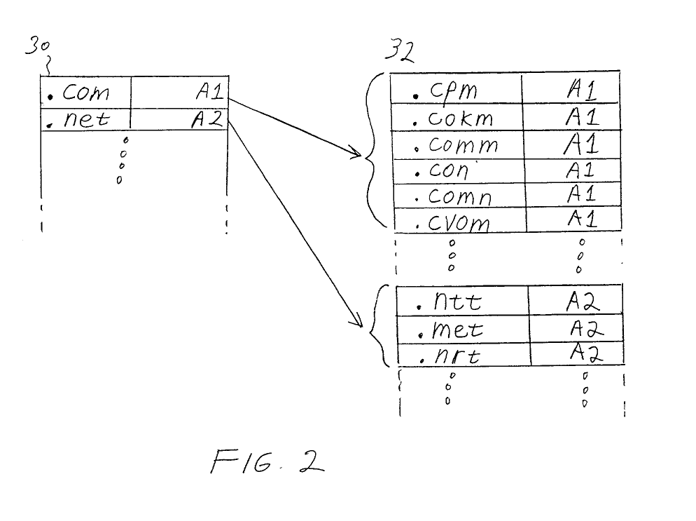

Referring now to FIG. 2, there is shown an exemplary embodiment of a root zone file 30, and a set of supplemental DNS entries for the pseudo TLDs. As shown therein, the DNS entry for “.com” in the root zone file 30 provides an IP address designated therein as “A1”, corresponding to the IP address of the .com zone server 26. The DNS entry for “.net” in the root zone file 30 provides an IP address designated therein as “A2”, and so on for each of the TLDs specified in the root zone file 30. Within the supplemental DNS entries 32, the pseudo TLDs specified therein each correspond to a mis-typed version of one of the TLDs specified in the root zone file 30. For example, for mis-typed versions of “.com”, the supplemental DNS entries 32 include entries for the pseudo TLDs .cpm, .cokm, comm, .con., .cok, .comn, .cvom, which are common mis-typings for .com, resulting from adjacencies of various characters on a standard QWERTY keyboard. For mis-typed versions of “.net”, the supplemental DNS entries include, for example, such variations as .ntt, .met, .nrt, etc.

In the supplemental DNS entries, each of the pseudo-TLDs is associated with the same IP address as the corresponding correctly typed TLD. For example, each of .cpm, .cokm, .con, .cok, .comn are associated with the address “A1”, specifying the .com zone server 26. Hence, when the root server 28 receives a DNS query for any of these common mis-spellings for “.com”, the root server 28 will respond by providing the IP address for the .com server. The supplemental TLD entries may further include appropriate time-to-live values for the pseudo-TLDs. Consequently, the DNS cache of the intermediate name server will store DNS entries corresponding to the pseudo TLDs, resulting in a significant decrease in the DNS traffic load on the root server 28 due to mis-typed TLDs.

In order to maintain current correct IP address data for the pseudo TLDs, the supplemental DNS entries are preferably updated whenever the root zone file is updated. Concurrent with each update of the actual TLDs, the IP address and other DNS data associated with each TLD is copied to each of the corresponding pseudo TLDs. The supplemental DNS entries may be stored in a secondary file separate from the root zone file providing primary DNS data, as shown in FIG. 1. Alternatively, the supplemental DNS entries may be provided along with the primary DNS entries in a single root zone file.

As described thus far, the invention as implemented at the root server 28 would provide a substantial decrease in root server load. Alternatively, or in addition thereto, the present invention can be desirably implemented at the intermediate DNS server by, for example, an Internet service provider, in order to reduce bandwidth consumed by DNS traffic resulting from mis-typed domains. In such an embodiment, the Internet service provider may configure its DNS cache to include the supplemental DNS entries in a supplemental cache file, or within the cache 24. The IP addresses and other DNS data contained within the supplemental DNS data in such an embodiment, would be updated whenever the cache data for the corresponding TLDs is updated by receiving an authoritative response from the root server for the TLDs specified in the root zone file. Furthermore, it will be appreciated that the inventive method of providing supplemental DNS data for the pseudo TLDs may be implemented at the local host itself by, particularly for resolvers which implement the functions performed in by the intermediate name server described above, or by local hosts (or intermediate name servers) which are configured to provide a mirror of the root zone file.

In another alternative embodiment of the invention, it may be desirable to provide a mechanism to alert the user to the presence of a mis-typed TLD in order to notify the user of the typographical error, or to provide the user with the option of proceeding with address resolution. In such an embodiment, the supplemental DNS entries may be configured to provide an IP address of an address correction server 40. The address correction server 40 will then receive all address resolution queries for second-level domains within domain names having a mistyped TLD. For each query received, the address correction server will store the requested second-level (and higher) domain name received, and will provide the IP address of the address correction server as a response to the DNS query. When the resolver completes address resolution, by providing each level of the requested domain name to the address correction server 40, the address correction server will ultimately provide the IP address of an address correction prompt page 44 (for http queries).

The address prompt page 44 is preferably hosted at the address correction server 40, but may be hosted elsewhere. The address prompt page 44 is a dynamic web page including an active component, such as may be generated by a PERL script or other known dynamic HTML mechanism, which provides the user a message such as “You have been sent to <mis-typed domain name provided in address query>. Do you want to go to <correctly-typed domain name>?” where <correctly-typed domain name> includes a hyperlink to the correctly-typed domain name. In order to generate such a message, the address correction server 40 is provided with a database 41, similar in structure to the supplemental DNS entries described above, and configured as shown in FIG. 2. In order to construct the hyperlink for <correctly-typed domain name>, the active component retrieves the correctly-spelled TLD corresponding to the mis-typed TLD which caused the original query to be referred to the address correction server 40.

The method of the invention as implemented via an address correction server 40 provides an additional safeguard against excess DNS traffic caused by mis-typed domain names. It may be that the user who has mis-typed a TLD may have mis-typed other portions of the domain name. Because many mis-spellings of second-level domain names are registered for the purpose of “mousetrapping” users, or providing web pages having irrelevant and often offensive content, the address correction server provides the user with the option of specifying the complete correct desired domain name, if other portions have been mis-spelled, or of proceeding to the address including the correctly-spelled TLD. The address correction server 40 also provides a useful diagnostic mechanism for web page authors, because mis-typed domain name queries may just as easily result from a typographical errors present on a web page, in addition to mis-typed address inquiries resulting from user keyboard error.

In a further alternative embodiment, address correction may be offered on a subscription basis to owners of registered second-level domains in the various TLDs. For example, the address correction server 40 may be configured to operate as a TLD zone server such that the “address correction database” consists of zone files for each of the misspelled TLD's for which service is to be offered. In such an embodiment, the “.comm” zone DNS entries, for example, would consist of a mirror of the .com zone file entries for each .com registrant who has elected to subscribe to the address correction service. By maintaining the misspelled TLD zone files as mirrors of the respective TLD zone files, filtered according to the subscribers who have elected address correction, such an embodiment would prevent web or e-mail traffic hijacking by persons seeking to utilize the address correction method in order to obtain web or e-mail traffic intended for various SLDs within the correctly-spelled TLDs. Such a subscription-based routing mechanism may alternatively be provided by the intermediate DNS server utilizing a DNS cache or supplement thereto in order to perform the address-correction method of the present invention.

The preceding terms are intended by way of exemplary description, and not as terms of limitation. It will be appreciated that the invention described by way of example hereinabove is susceptible to obvious modification by one of ordinary skill in the art. The invention is thus applicable to embodiments, other than those specified above, wherever re-routing of Internet data is desired in response to mis-typed or otherwise incorrectly-specified TLDs may occur. For example the present invention is applicable to hypertext transfer protocol, as described, in addition to simple mail transfer protocol (SMTP), file transfer protocol (FTP), telnet, and other existing and future Internet-enabled applications.

That which is claimed is:

1. A method of resolving Internet addresses, comprising the steps of:
configuring a name server to provide IP addresses for a plurality of top-level domains;
further configuring the name server to provide IP addresses for pseudo top-level domains, wherein each pseudo top-level domain corresponds to a mistyped representation of one of said plurality of top-level domains; and
operating the name server to respond to DNS queries by providing IP addresses to the plurality of top-level domains and the pseudo top-level domains.

2. The method of claim 1 wherein the name server is a root server.

3. The method of claim 1 wherein the name server is an intermediate DNS server, the method comprising the step of:
configuring the intermediate DNS server to query a root server to obtain IP addresses for the plurality of top-level domains; and
updating the intermediate DNS server to provide an IP addresses for each pseudo top-level domains on the basis of IP addresses obtained from the root server for the corresponding one of the plurality of top-level domains.

4. The method of claim 1 wherein the name server is located on a local host connected to the Internet.

5. An Internet address resolution system, comprising:
a root zone file, containing primary DNS entries corresponding to each of a plurality of top-level domains;
a plurality of supplemental DNS entries corresponding to each of a plurality of pseudo top-level domains, wherein each pseudo top-level domain consists of a mis-typed version of one of the plurality of top-level domains;
a name server, connected to the Internet to respond to address resolution queries, and configured to provide (a) DNS data retrieved from the primary DNS entries of the root zone file in response to queries directed to one of the plurality of top-level domains, and (b) DNS data retrieved from the supplemental DNS entries in response to queries directed to one of the pseudo top-level domains.

6. The address resolution system of claim 5 wherein the name server is a root server, and wherein the primary DNS entries and the supplemental DNS entries are both stored at the root server.

7. The address resolution system of claim 6 wherein the supplemental DNS entries are located in the root zone file.

8. The address resolution system of claim 5 wherein the supplemental DNS entries are stored at an intermediate DNS server.

9. The address resolution system of claim 8 wherein the root zone file is stored at a root server, and wherein the name server is an intermediate DNS server configured to obtain DNS data from the root server in response to address resolution queries directed to the plurality of top-level domains, and to update the supplemental DNS entries for each of the pseudo TLDs on the basis of DNS received in response to queries intended for corresponding one of the plurality of TLDs.

10. The address resolution system of claim 5 wherein the supplemental DNS entries are configured to respond with an error correction message in response to a query directed to a pseudo top-level domain.
